(19) United States
(12) Patent Application Publication
(10) Pub. No.: US 2012/0119743 A1
(43) Pub. Date: May 17, 2012

(54) MULTI-MODE ELECTROMAGNETIC SURVEYING

(76) Inventor: Johannes Maria Singer, Schwarzenfeld (DE)

(21) Appl. No.: 13/378,149

(22) PCT Filed: Jun. 17, 2010
(86) PCT No.: PCT/US10/38950

§ 371 Date: Jan. 25, 2012

Related U.S. Application Data
(60) Provisional application No. 61/218,517, filed on Jun. 19, 2009.

(51) Int. Cl. G01V 3/10

(52) U.S. Cl. 324/334

(57) ABSTRACT

A method for providing information about a region below the earth's surface, comprises a) providing data from a system comprising an inductive source providing inductive signals in the region and a plurality of galvanic receivers for receiving galvanic signals resulting from the inductive signals, wherein the galvanic signals are the result of mode conversion occurring in the subsurface region; and b) processing the data. Step b) may include generating at least one galvanic virtual source signal.

### RELATED CASES

This application claims priority to U.S. application Ser. No. 61/218,517, filed on Jun. 19, 2009, which is incorporated herein in its entirety.

### FIELD OF THE INVENTION

The invention relates to the use of induced and naturally-occurring signal modes to obtain information about subsurface formation. More specifically, the invention relates to multi-mode electromagnetic data collection and interpretation.

### BACKGROUND OF THE INVENTION

Electromagnetic surveying of subsurface formations typically entails the use of either electric or galvanic sources and either electric or galvanic receivers, depending on the nature of the formation.

Galvanic sources are coupled via electric/galvanic contacts or “poles” into the earth; in a dipole source, an electric current flows between two contacts through the subsurface. Galvanic receivers are coupled via electric/galvanic contacts or poles into the earth; in a dipole receiver, an electric voltage created by a current flowing through the earth is measured between two contacts. Galvanic receivers can be single- or multi-component (x,y,z).

Inductive sources are coupled via magnetic induction into the earth, without any galvanic connection. An electric current is generated typically by exciting an electric current in a single or multi-stranded loop or “coil,” which via magnetic induction generates another signal in the subsurface. Inductive sources can have arbitrary shapes and configurations and orientations. Inductive receivers measure an electromagnetic signal via inductive coupling to the earth. Various types of magnetic field sensors or “magnetometers” can be used, including without limitation single or multi-stranded coils of various shapes and sizes, and devices using Hall-effect, flux-gate, SQUID, proton-precession or other physical effects. Inductive receivers do not require galvanic connection to the ground.

Lastly, magnetotelluric stations are passive EM receivers that record the response of telluric electromagnetic fields after passing through the subsurface; they typically use both electric and inductive devices to record electric and magnetic responses, respectively, i.e. responses from inductive and galvanic modes. Electric devices may comprise galvanically coupled dipoles, while magnetic devices may comprise magnetic coils, flux gate sensors or SQUID devices.

Land controlled source electromagnetic (CSEM) data are typically acquired using galvanically coupled sources and receivers to detect subsurface resistors. In many instances, the detected resistors are relatively thin resistors disposed in a relatively high-conductivity background rock formation. For example, the background rock/sediment may have a resistivity of 1-5 Ohm.m, compared to and a standard hydrocarbon reservoir having a resistivity of 10-100 Ohm.m, making it difficult to detect a conductor/resistor interface—the approach required for mapping and detection of subsurface hydrocarbon accumulations.

Galvanically coupled signals are conventionally preferred in these instances, as they allow relatively easy detection of a thin resistor within a conductive background interface, whereas inductive techniques such as loop/coil based systems or typical magnetotelluric techniques are more sensitive to finding a conductor within a resistive background such as a low resistivity sediment under high-resistivity igneous rock or salt. Inductive magnetic loop-based techniques are wide-spread in the mining industry, for example.

Operationally, galvanic and inductive techniques are quite different. When a galvanic source is used, a dipole EM source is brought into galvanic contact with the subsurface so as to directly inject a current into a low-resistivity near surface region. To achieve high currents and thus high signal levels, the galvanic contact resistivity between the CSEM source and the subsurface needs to be as low as possible. Sufficiently conductive contact is achievable only in humid areas, and even then a significant effort has to be made to lower the overall electric contact resistance.

By contrast, when an inductive source is used, an EM signal is inductively coupled into the subsurface, without the need for a good galvanic contact. In fact, an inductive source works best if the near surface is higher in resistivity, as the induced current will less strongly attenuate. A practical inductive source comprises a large cable loop placed on the ground, having no direct galvanic contact to the ground, and energized by an electric transmitter. The major physical disadvantage is that the inductive system also creates transverse electric (“TE”) modes, which are not particularly sensitive to the conductor/resistor interfaces that are useful for identifying hydrocarbons.

Current practice teaches that galvanic sources typically transmit into galvanic receivers, i.e. dipole electric field receivers at an offset, while inductive sources typically transmit into inductive receivers, i.e. loop receivers that are concentric with the source or at a finite offset.

It is difficult to place a galvanic source dipole into even medium contact resistivity subsurface. On the other hand, while electric sources are impractical, electric field/galvanic sensors are capable of recording signals at contact resistivities up to several hundred kOhm. Specialized receiver electrodes are commercially available to detect/receive the CSEM signal at high ground contact values. Thus, large contact resistivity does not entirely prevent the recording of data.

Nonetheless, there remains a need for a system that can provide useful survey information regarding deep hydrocarbon formations.

### SUMMARY OF THE INVENTION

In accordance with preferred embodiments of the invention there is provided a system that can provide useful survey information regarding deep hydrocarbon formations, even when it is difficult to achieve galvanic coupling to the earth.

In some embodiments, a system for providing information about a region below the earth's surface comprises an inductive source providing inductive signals in the region and a plurality of galvanic receivers for receiving galvanic signals resulting from the inductive signals, wherein the galvanic signals are the result of mode conversion occurring in the subsurface region. The inductive source may comprise either a magnetotelluric field or a conductive loop that is not substantially galvanically coupled to the earth and the receivers may comprise electric dipoles.

In other embodiments, a method for providing information about a region below the earth's surface comprises a) providing data from a system comprising an inductive source providing inductive signals in the region and a plurality of galvanic receivers for receiving galvanic signals resulting from the inductive signals, wherein the galvanic signals are the result of mode conversion occurring in the subsurface region; and b) processing the data. Step b) may include generating at least one virtual source signal, which may be a galvanic virtual source signal. The virtual source signal may originate at the inductive source or at one of the galvanic receivers.

As used in this specification and claims the following terms shall have the following meanings:

“MT”—stands for “Magnetotellurics” and refers to a technique using the telluric fields, the Earth's naturally varying electric and magnetic fields, as a source. The magnetic fields are produced by the interaction between the solar wind and the magnetosphere and by some weather conditions.
“TE” refers to “tranverse electric” modes.
“TM” refers to “tranverse magnetic” modes.
“Surface” refers to the surface of the earth, including the earth-air interface on land, and the seafloor in marine applications.

References to a subsurface being “non-1D” mean that the underground (“subsurface”) is not a strictly layered system but instead has finite extent, non-uniform (2-dimensional or 3-dimensional) resistivity anomalies. In real-world systems, almost no subsurface features can be described as 1-D. The most obvious deviation from one-dimensionality would be the presence of a reservoir, in particular reservoir boundaries, surface topography, dunes, faults etc.

References to “virtual source” are intended to refer to a method of imaging a subsurface formation using an array of sources and/or an array of receivers, wherein a virtual source is created at a selected receiver location, time-reversing a portion of the signal related to the selected source and receiver and convolving the time-reversed portion of the signal with the signal at adjoining receivers within the array and repeating the process for signals attributable to various sources to create an image of a target formation. The concept of virtual sources is described in U.S. Pat. No. 6,747,915. In mathematical terms, the generation of virtual source data as described in the '915 patent is as follows: a method of imaging a subsurface formation using a set of sources i and a set of receivers j comprises the steps of (a) recording with the set of receivers j the signals tᵢⱼ (t) obtained from activating the set of sources i; (b) selecting a receiver m as the location of a virtual source; (c) selecting a receiver k, wherein k is in a predetermined range around the position of receiver m; (d) selecting a source n from the sources i; (e) time-reversing at least a part of the signal tₙₘ (t) to obtain a time-reversed signal tₙₘ (31 t); (f) convolving the time-reversed signal tₙₘ (−t) with the signal tₙₖ (t) to obtain the convolved signal t^{conv}ₙₘₙₖ=tₙₘ−(t)·tₙₖ(t); (g) selecting a next source n, repeating steps (e) and (f) until a predetermined number of sources have had their turn; (h) summing the convolved signals over the sources n to obtain a signal tₘₖ^{vs}(t)=Σₙtₙₘₙₖ^{conv}, where t^{vs}ₘₖ (t) is the signal received by a receiver at the position k from a virtual source at the position of receiver m; (i) repeating steps (c) through (g) over k; (j) repeating steps (b)-(h) over m to generate a survey with virtual sources m and receivers k; and (k) further processing the virtual source signals to obtain an image. The concepts set out in the '915 patent can be formally and technically extended to electromagnetic (“diffusive”) fields.

### BRIEF DESCRIPTION OF THE DRAWINGS

For a more detailed understanding of the invention, reference is made to the accompanying wherein:

FIGS. 1 and 2 are schematic representations of conventional galvanic and inductive electromagnetic surveying systems, respectively;

FIG. 3 is a schematic representations of one embodiment of a system in accordance with the present invention;

FIG. 4 is a schematic representations of a second embodiment of a system in accordance with the present invention;

FIG. 3 is a schematic representations of a third embodiment of a system in accordance with the present invention; and

FIG. 3 is a schematic representations of a fourth embodiment of a system in accordance with the present invention.

### DETAILED DESCRIPTION OF A PREFERRED EMBODIMENT

According to preferred embodiments of the invention, combinations of inductive and galvanic sources and/or combinations of inductive and galvanic receivers are used to obtain information about the subsurface.

It known that significant mode conversions occur in the subsurface. These mode conversions may be between transverse electric (TE) and transverse magnetic (TM) galvanic/inductive modes. Any 3D resistivity anomaly in the subsurface will create significant converted modes. An example is the “tipper” vertical MT mode that results from 3D subsurface, while assuming a strictly plane magnetic source field. For example, a surface conductivity anomaly may deflect induced horizontal electric currents into a vertical plane, thereby converting transverse-electric (TE) mode currents into a TM mode. Thus, any realistic, i.e. 3D, subsurface will naturally generate a significant mixture of both modes, regardless of source.

The present invention takes advantage of these mixed modes to enable effective data collection that would heretofore have been impractical or impossible. In particular, in high-contact resistivity areas, a CSEM approach with an inductive loop source and a series of galvanic field receivers is used. The receivers may be disposed in a 2D line or a 3D grid and the receivers themselves may be MT receiver stations or similar setups, using galvanic and inductive receivers and therefore allowing for the recording of both magnetic and electric signals. The fields induced by the loop source will be converted into a mixture of inductive and galvanic modes in the subsurface if the subsurface is non-1D. The resulting signals will include both TE and TM modes.

Similarly, it is possible to create out of the inductively generated source signal a virtual galvanic source firing into real galvanic receivers. Thus, using interferometry techniques, the inductive signal and its secondary galvanic component created in the subsurface can be used to create at any of the galvanic receivers on the surface a virtual galvanic source sending a EM signal through the subsurface into a galvanic receiver at offset. Thereby, inductive source data could be analyzed as if it were data from a virtual galvanic source to a galvanic receiver, while completely avoiding the near-surface contact resistivity problem.

Thus, the present invention allows a significant extension of the portfolio of applications for land CSEM, using known electric and magnetic receivers and galvanic and inductive sources. Using the techniques disclosed herein, accurate CSEM surveys can be made in arid areas or other instances of high near-surface resistivity, where a galvanic source may be substantially ineffective. Moreover, by recording both modes, the direct and the converted from either a galvanic or inductive source, the description of the subsurface resistivity structure may be significantly improved due to the different individual sensitivities. And finally creating virtual galvanic or inductive source out of the complementary real source type allows a simple integration and processing with a conventional interpretation stream. It even opens the possibility to turn passive (magnetotelluric) inductive sources into virtual active galvanic sources.

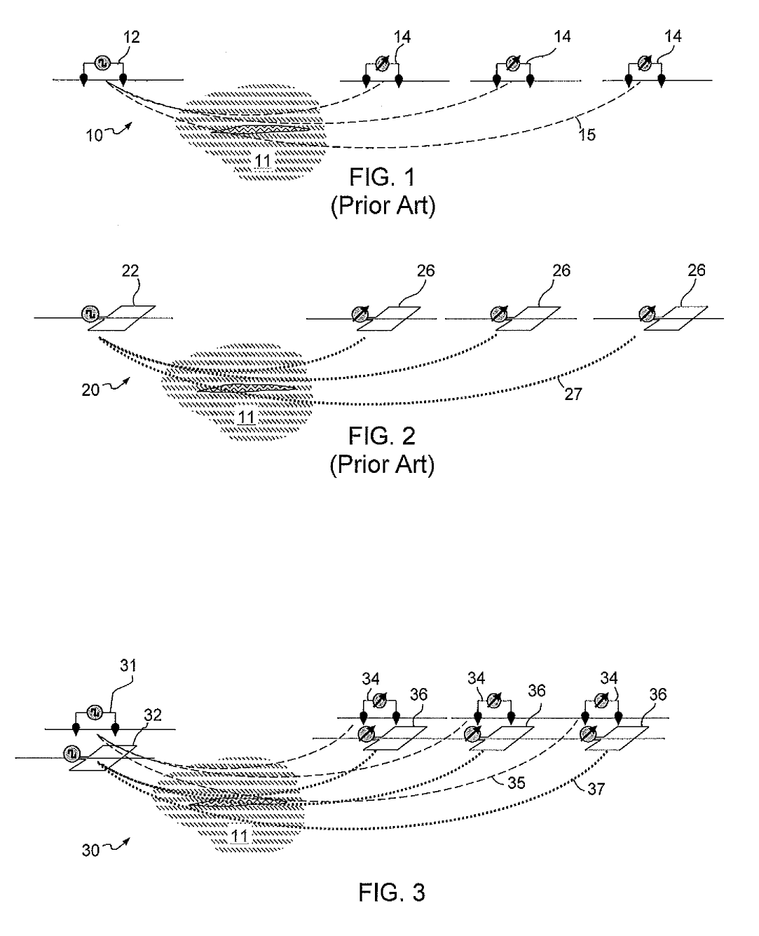

Referring now to FIGS. 1 and 2, conventional systems typically comprise single-mode sets of sources and receivers. For example, a galvanic system 10 may comprise a galvanic source 12 and a plurality of galvanic receivers 14. Electrical signals 15 from source 12 are transmitted through the formation 11 and received at receivers 14. Similarly, an inductive system 20 may comprise a galvanic source 22 and a plurality of galvanic receivers 26. Magnetic signals 27 from source 22 are transmitted through the formation 11 and received at receivers 26. As discussed above, certain modes are better-suited for certain applications.

Referring now to FIG. 3, one embodiment of a system in accordance with the present invention comprises a multi-mode system 30 that includes both galvanic and inductive elements. Specifically, system 30 may comprise a combined source having galvanic and inductive components 31, 31, respectively and dual receivers 34 (galvanic) and 36 (inductive). Depending on the coupling, the formation, and the orientation of the source and receivers, electric signals 35 and magnetic signals 37 may be received at the respective galvanic and inductive receivers 34, 36. Thus, system 30 is expected to be sensitive to both subsurface conductors and resistors and will allow synthetic creation of a either a galvanic or inductive virtual source at any of the dual receiver stations.

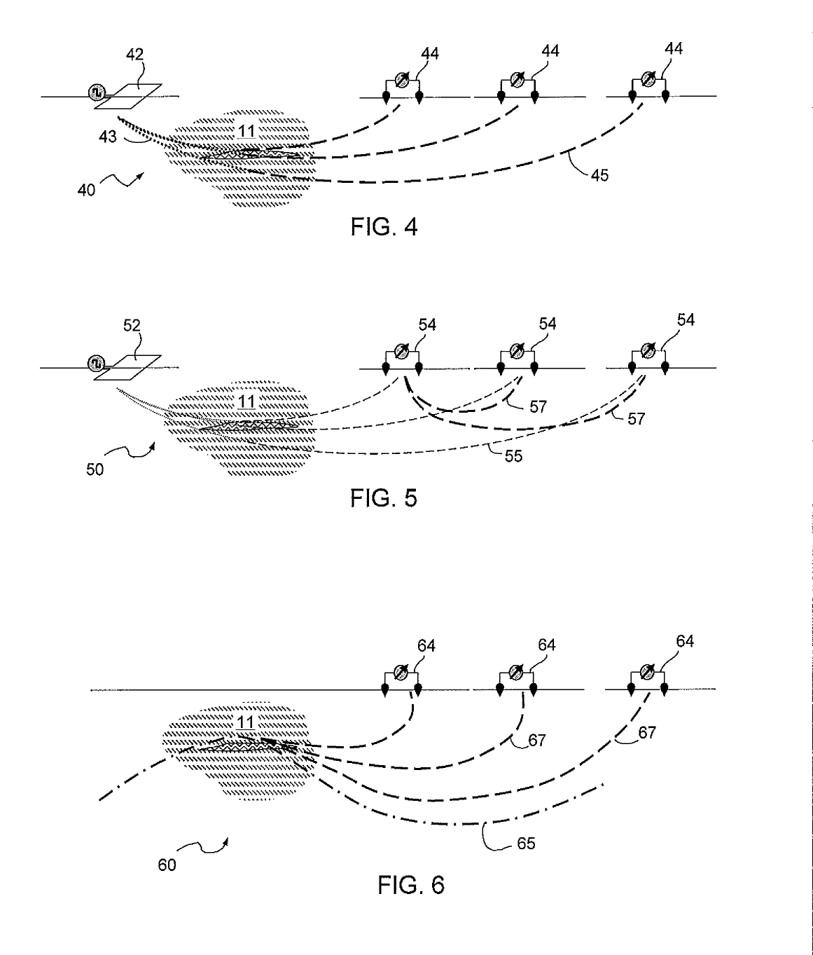

Referring now to FIG. 4, an alternative embodiment of the invention takes advantage of the mode conversions that occur in the subsurface. In this embodiment a surveying system 40 comprises an inductive source 42 and a plurality of galvanic receivers 44. Because source 42 is an inductive source, it avoids the disadvantages associated with galvanic sources, namely the need for conductive coupling. Instead source 42 creates signals 43 in the subsurface. As they pass through formation 11, a portion of signals 43 are converted into electric current and become electric signal 45. The more pronounced the subsurface features are, the more mode conversion will occur. Electric signals 45 are detectable by galvanic receivers 44. Thus, system 40 provides effective hydrocarbon exploration data, even in arid zones or regions that are otherwise not suitable for galvanic surveying.

Turning to FIG. 5, in still another embodiment, the invention includes using a mixed system and mode-converted signals to obtain virtual source data. Specifically, in one preferred embodiment, a surveying system 50 comprises an inductive source 52 and a plurality of galvanic receivers 54. The galvanic signals 55 that are received at receivers 54 as a result of mode conversion are processed using a correlation or deconvolution virtual source techniques so as to generate a set of “virtual signals” 57. Each virtual signal 57 simulates a signal received at one receiver from a “virtual source” positioned at the location of a second receiver. Using virtual source analysis allows the generation of virtual galvanic sources from real inductive sources, or vice versa. Possible real inductive sources include naturally occurring telluric fields.

Finally, referring to FIG. 6, a system 60 comprises a plurality of galvanic receivers 64 that detect electric signals resulting from magnetotelluric fields, illustrated at 65. Like the signals created by inductive sources 42 and 53, MT fields 65 undergo mode conversion as they pass through the subsurface. Some of this conversion results in galvanic signals 67, which are detected by receivers 64.

As set forth herein, the present invention provides a method by which electromagnetic surveys can be conducted in regions that are not conducive to galvanic coupling, and which can yield useful information about subsurface features that are not readily detected by conventional systems.

Although the invention has been described with reference to several exemplary embodiments, it is understood that the words that have been used are words of description and illustration, rather than words of limitation. Changes may be made within the purview of the appended claims, as presently stated and as amended, without departing from the scope of the invention in its aspects.

It will further be understood that the sources and receivers of the present invention are intended to be used in combination with any suitable deployment, retrieval, data collection, data processing, and output devices, such as are known in the art.

1. A system for providing information about a region below the earth's surface, comprising:
an inductive source comprising a magnetotelluric field for providing inductive signals in the region; and
a plurality of galvanic receivers for receiving galvanic signals resulting from the inductive signals, wherein the galvanic signals are the result of mode conversion occurring in the subsurface region.

2. The method according to claim 1 wherein the inductive source comprises a conductive loop that is not substantially galvanically coupled to the earth and the receivers comprise electric dipoles.

3. The method according to claim 1 wherein the receivers comprise electric dipoles.

4. A method for providing information about a region below the earth's surface, comprising:
a) providing data from a system comprising:
an inductive source comprising a magnetotelluric field and providing inductive signals in the region; and
a plurality of galvanic receivers for receiving galvanic signals resulting from the inductive signals;
wherein the galvanic signals are the result of mode conversion occurring in the subsurface region; and
b) processing the data.

5. The method according to claim 4 wherein the inductive source comprises a conductive loop that is not substantially galvanically coupled to the earth.

6. The method according to claim 4 wherein the inductive source comprises a magnetotelluric field.

7. The method according to claim 4 wherein step b) includes generating at least one virtual source signal.

8. The method of claim 7, wherein the virtual source signal is a galvanic virtual source signal.

9. The method according to claim 7 wherein the virtual source signal originates at the inductive source.

10. The method according to claim 7 wherein the virtual source signal originates at one of the galvanic receivers.

11. The method according to claim 4 wherein the receivers comprise electric dipoles
